(19) United States
(12) Patent Application Publication
(10) Pub. No.: US 2019/0259347 A1
(43) Pub. Date: Aug. 22, 2019

(54) DISPLAY DEVICE AND DRIVER

(71) Applicant: Sharp Kabushiki Kaisha, Sakai City (JP)

(72) Inventors: Shige FURUTA, Sakai City (JP); Nami NAGIRA, Sakai City (JP); Hidekazu YAMANAKA, Sakai City (JP); Yasuyoshi KAISE, Sakai City (JP); Takahiro YAMAGUCHI, Sakai City (JP); Kohei HOSOYACHI, Sakai City (JP); Yuhichiroh MURAKAMI, Sakai City (JP)

(21) Appl. No.: 16/238,546

(22) Filed: Jan. 3, 2019

(30) Foreign Application Priority Data
Feb. 16, 2018 (JP) 2018-026449

(51) Int. Cl. G09G 3/36

(52) U.S. Cl. CPC G09G 3/3677; G09G 2300/04; G09G 2310/06; G09G 2320/0233

(57) ABSTRACT

A display device includes: an mth scanning signal line to which a plurality of sub pixels are connected; an nth scanning signal line to which a sub pixel is connected, the number of sub pixels which are connected to the nth scanning signal line being lower than the number of sub pixels which are connected to the mth scanning signal line; and a driver circuit which includes a plurality of output circuits and which drives the mth scanning signal line and the nth scanning signal line, an mth one of the plurality of output circuits including an mth output transistor connected to the mth scanning signal line, an nth one of the plurality of output circuits including an nth output transistor connected to the nth scanning signal line, a driving capability of the nth output transistor being lower than that of the mth output transistor.

This Nonprovisional application claims priority under 35 U.S.C. § 119 on Patent Application No. 2018-026449 filed in Japan on Feb. 16, 2018, the entire contents of which are hereby incorporated by reference.

### TECHNICAL FIELD

The present invention relates to a display device.

### BACKGROUND ART

Patent Literature 1 discloses a technique of suppressing luminance unevenness in a display area having an irregular shape (such a shape that corners are obliquely cut off).

### CITATION LIST

### Patent Literature

[Patent Literature 1] Japanese Patent Application Publication, Tokukai, No. 2012-103335 (published on May 31, 2012)

### SUMMARY OF INVENTION

### Technical Problem

According to the technique disclosed in Patent Literature 1, there is a problem that a shape of the display area is limited. In addition, there is a problem that adjustment of a data signal is needed.

### Solution to Problem

A display device in accordance with an aspect of the present invention is a display device including: an mth scanning signal line to which a plurality of sub pixels are connected; an nth scanning signal line to which a sub pixel is connected, the number of sub pixels which are connected to the nth scanning signal line being lower than the number of sub pixels which are connected to the mth scanning signal line; and a driver circuit which includes a plurality of output circuits and which drives the mth scanning signal line and the nth scanning signal line, an mth one of the plurality of output circuits including an mth output transistor connected to the mth scanning signal line, an nth one of the plurality of output circuits including an nth output transistor connected to the nth scanning signal line, a driving capability of the nth output transistor being lower than that of the mth output transistor.

### Advantageous Effects of Invention

According to an aspect of the present invention, it is possible to suppress luminance unevenness in a display area having, for example, an irregular shape.

### BRIEF DESCRIPTION OF DRAWINGS

(a) of FIG. 1 is a schematic view illustrating a configuration of a display device in accordance with Embodiment 1. (b) of FIG. 1 is a cross-sectional view illustrating the configuration of the display device. (c) of FIG. 1 is a circuit diagram illustrating a sub pixel.

(a) of FIG. 2 is a schematic view illustrating a configuration of a gate driver in accordance with Embodiment 1. (b) of FIG. 2 is a timing chart illustrating operation of the gate driver.

(a) of FIG. 3 is a schematic view illustrating a configuration of another gate driver in accordance with Embodiment 1. (b) of FIG. 3 is a timing chart illustrating operation of the another gate driver.

FIG. 4 is an explanatory view illustrating configurations of output circuits in accordance with Embodiment 1.

FIG. 5 is a waveform chart illustrating an effect of Embodiment 1.

FIG. 6 is a waveform chart illustrating a waveform of Comparative Example.

FIG. 7 is a plan view illustrating configurations of output transistors.

FIG. 8 is a schematic view illustrating variations of the display device in accordance with Embodiment 1.

FIG. 9 is a schematic view illustrating other variations of the display device in accordance with Embodiment 1.

FIG. 10 is a schematic view illustrating configurations of a display device in accordance with Embodiment 2.

FIG. 11 is a schematic view illustrating variations of the display device in accordance with Embodiment 2.

(a) of FIG. 12 is a schematic view illustrating a configuration of a display device in accordance with Embodiment 3. (b) of FIG. 12 is an enlarged view of a corner of a display area.

### DESCRIPTION OF EMBODIMENTS

(a) of FIG. 1 is a schematic view illustrating a configuration of a display device in accordance with Embodiment 1. (b) of FIG. 1 is a cross-sectional view illustrating the configuration of the display device. (c) of FIG. 1 is a circuit diagram illustrating a sub pixel. As illustrated in FIG. 1, a display device 2 includes a backlight unit BU, a liquid crystal panel LP, a source driver SD, and a display control circuit DCC. A gate driver GD1 and a gate driver GD2 are monolithically provided to the liquid crystal panel LP (GDM structure). The display control circuit DCC controls the source driver SD, the gate driver GD1, and the gate driver GD2.

The liquid crystal panel LP includes (i) an active matrix substrate 3 which includes data signal lines DL, scanning signal lines including a scanning signal line Gm, a scanning signal line Gn, and a scanning signal line GN, the gate driver GD1, and the gate driver GD2, (ii) a liquid crystal layer 4, (iii) a color filter substrate 5 which includes a color filter, and (iv) a functional layer 6 which includes an optical film and touch panel.

A cutout NZ is provided in the liquid crystal panel LP. A plurality of sub pixels (SPm, SPn, SPM, SPN) are provided in a display area DA having an irregular shape.

A sub pixel SPi (i=m, n, M, N) includes a pixel transistor TR and a pixel electrode PE. The sub pixel SPi is connected to (i) a scanning signal line Gi (i=m, n, M, N), which extends in a first direction D1, and (ii) a data signal line DL, which extends in a second direction D2. Specifically, the pixel electrode PE is connected to the data signal line DL via the pixel transistor TR, and a gate electrode of the pixel transistor TR is connected to the scanning signal line Gi. A liquid crystal capacitance Clc is formed between the pixel electrode PE and a common electrode com, and a storage capacitance Ccs is formed between the pixel electrode PE and a storage capacitor wiring CSi. Note that the storage capacitor wiring CSi is provided to the active matrix substrate 3, and the common electrode com is provided to the active matrix substrate 3 or the color filter substrate 5. An oxide semiconductor (for example, an In—Ga—Zn—O-based semiconductor), low-temperature polysilicon (LTPS), or the like can be used for a channel of the pixel transistor TR.

### Embodiment 1

In FIG. 1, the gate driver GD1 and the gate driver GD2, each of which extends in the second direction D2, are provided in a non-display area NA which surrounds the display area DA. The display area DA includes (i) a side area SA1 that is located by one of sides of the cutout NZ which sides face each other in the first direction D1, (ii) a side area SA2 that is located by the other one of the sides of the cutout NZ, and (iii) a main area MA that is located further inside than the cutout NZ as viewed in the second direction D2 (in the middle in an up-and-down direction of (a) of FIG. 1). It is possible to dispose a camera lens, various sensors, and/or the like so that the camera lens, the various sensors, and/or the like are/is located in the cutout NZ.

The scanning signal line Gm (mth scanning signal line) is provided so as to pass through the main area MA, and is connected to the gate driver GD1 and the gate driver GD2. The scanning signal line Gn (nth scanning signal line) is provided so as to pass through the side area SA1, and is connected to the gate driver GD1. As viewed from the gate driver GD1, the scanning signal line Gm is the mth (m is a natural number) scanning signal line, the scanning signal line Gn is the nth (n is a natural number other than m) scanning signal line. The scanning signal line GN is provided so as to pass through the side area SA2, and is connected to the gate driver GD2. The scanning signal line Gm is driven by both of the gate driver GD1 and the gate driver GD2. The scanning signal line Gn is driven by the gate driver GD1. The number of sub pixels which are connected to the scanning signal line Gn is less than half of the number of sub pixels which are connected to the scanning signal line Gm. Therefore, as viewed from the gate driver GD1, the scanning signal line Gn is a low-load scanning signal line as compared with the scanning signal line Gm (the scanning signal line Gn is lower in time constant). Similarly, as viewed from the gate driver GD2, the scanning signal line GN is a low-load scanning signal line as compared with the scanning signal line Gm.

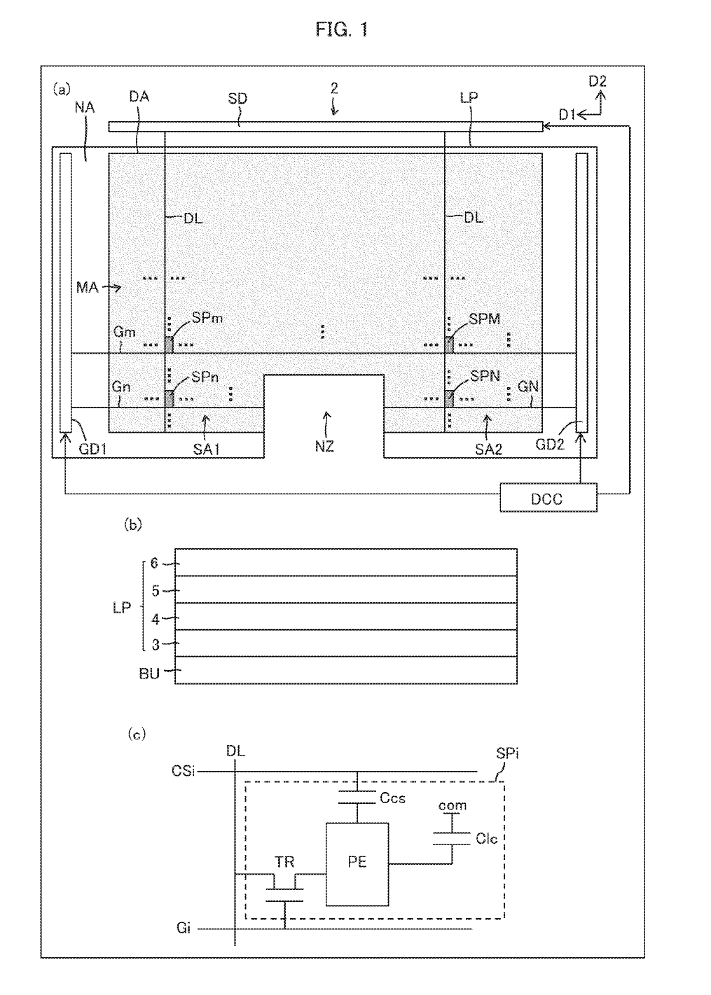

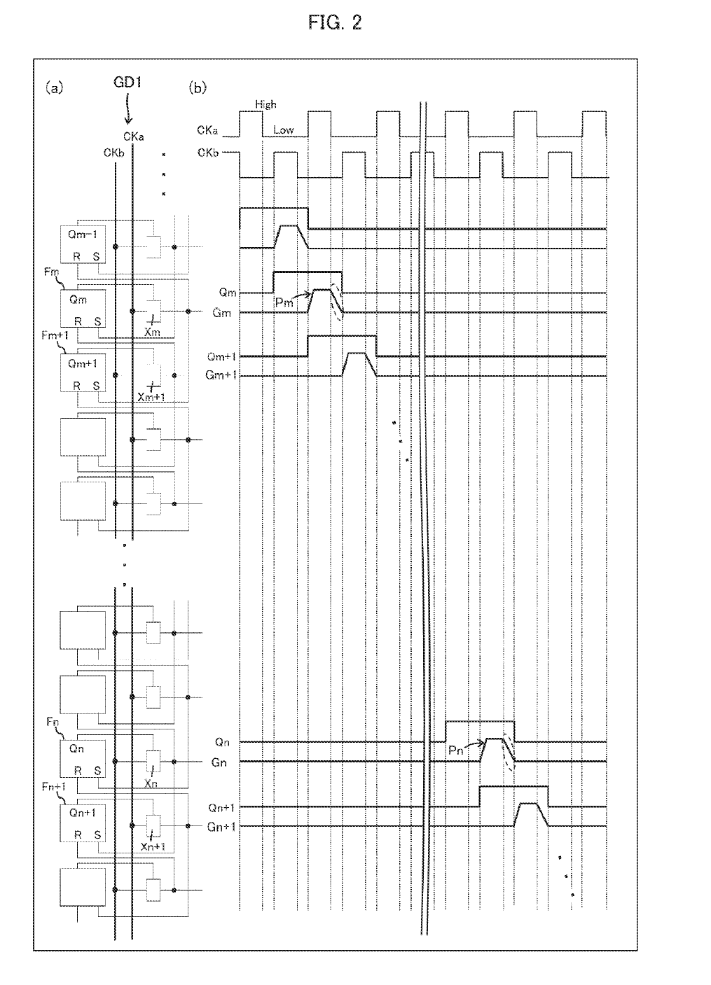

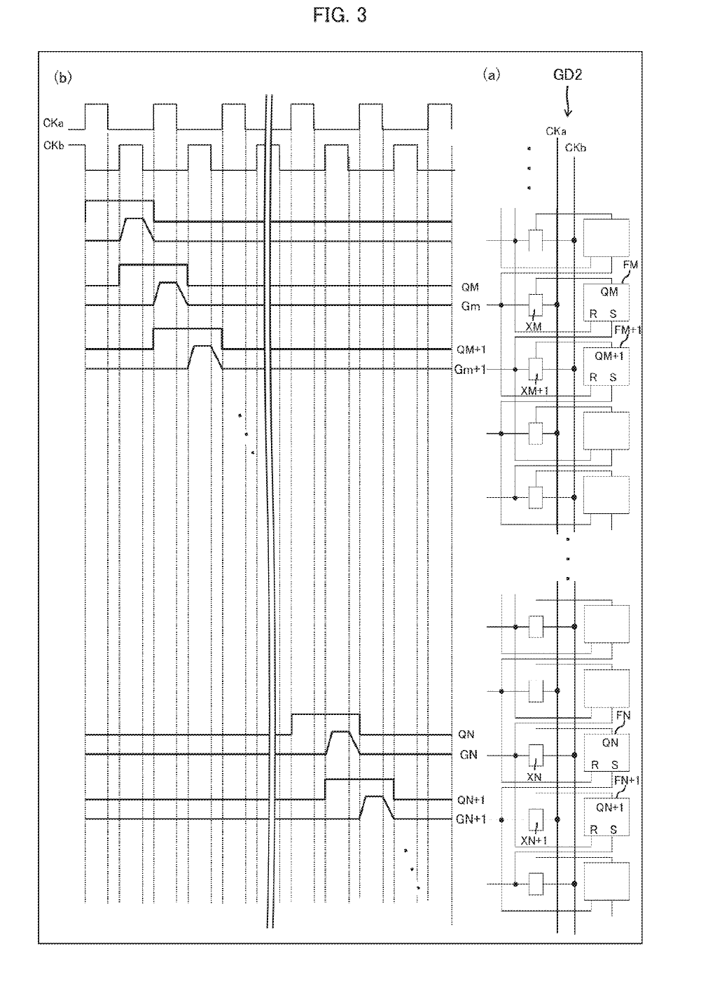

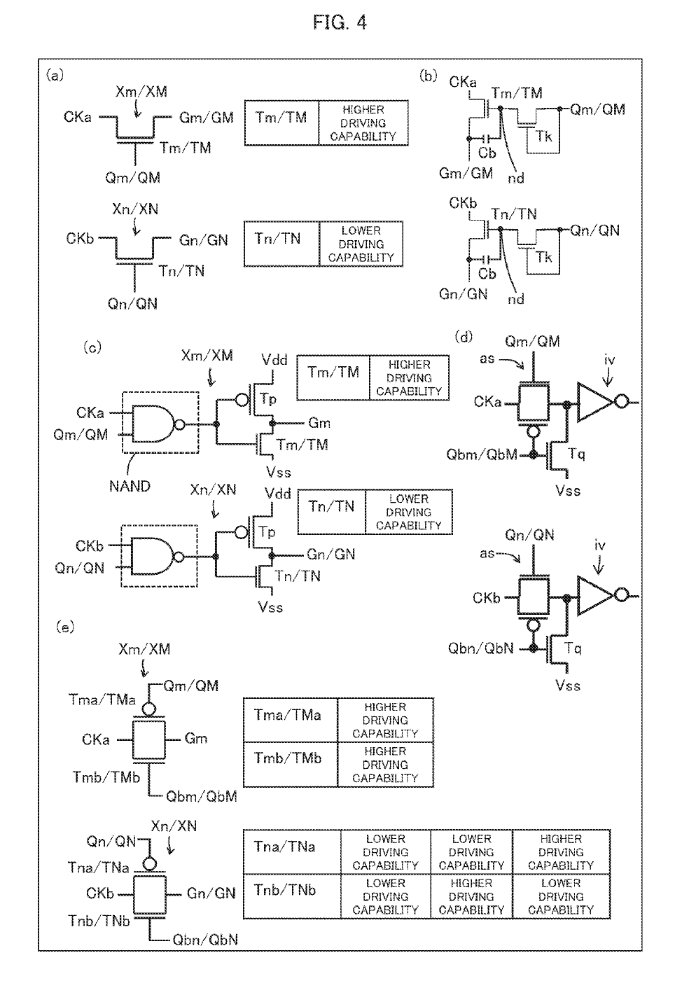

(a) of FIG. 2 is a schematic view illustrating a configuration of the gate driver GD1. (b) of FIG. 2 is a timing chart illustrating operation of the gate driver GD1. (a) of FIG. 3 is a schematic view illustrating a configuration of the gate driver GD2. (b) of FIG. 3 is a timing chart illustrating operation of the gate driver GD2. (a) and (b) of FIG. 4 are each an explanatory view illustrating configurations of output circuits in accordance with Embodiment 1. FIG. 5 is a waveform chart illustrating an effect of Embodiment 1.

According to Embodiment 1, the gate driver GD1 is configured as illustrated in FIGS. 2 and 4, and the gate driver GD2 is configured as illustrated in FIGS. 3 and 4, in consideration of the fact that the scanning signal line Gn, which is provided so as to pass through the side area SA1, and the scanning signal line GN, which is provided so as to pass through the side area SA2, are each a low-load scanning signal line.

Specifically, the gate driver GD1 includes a plurality of flip flops and a plurality of output circuits. An mth output circuit Xm connected to an mth flip flop Fm includes a transistor Tm (output transistor) connected to the scanning signal line Gm. An nth output circuit Xn connected to an nth flip flop Fn includes a transistor Tn (output transistor) connected to the scanning signal line Gn. A driving capability of the transistor Tn is lower than that of the transistor Tm. Note that a driving capability of a transistor is indicated by a drain current value which is obtained in a case where a voltage between a gate and a source is set to a given value (a transistor having a higher driving capability is capable of causing a flow of a larger drain current).

The gate driver GD2 includes a plurality of flip flops and a plurality of output circuits. An mth output circuit XM connected to an mth flip flop FM includes a transistor TM (output transistor) connected to the scanning signal line Gm. An nth output circuit XN connected to an nth flip flop FN includes a transistor TN (output transistor) connected to the scanning signal line GN. A driving capability of the transistor TN is lower than that of the transistor TM.

This allows each of a returning edge (falling edge enclosed by a broken line in FIG. 2) of a scanning pulse Pn, which is outputted from the output circuit Xn to the scanning signal line Gn, and a returning edge of a scanning pulse PN, which is outputted from the output circuit XN to the scanning signal line GN, to match a returning edge of a scanning pulse Pm, which is outputted from the output circuit Xm to the scanning signal line Gm, as illustrated in (b) of FIG. 2, (b) of FIG. 3, and FIG. 5. It is therefore possible to reduce luminance unevenness between the side area SA1, the side area SA2, and the main area MA.

As illustrated in FIG. 5, with regard to the scanning signal line Gm, a voltage Vp of each pixel electrode PE is pulled in a negative direction by ΔVm at a timing at which the scanning pulse Pm returns (falls), and, with regard to the scanning signal line Gn, a voltage Vp of each pixel electrode PE is pulled in the negative direction by ΔVn at a timing at which the scanning pulse Pn returns (falls). Such a feed-through voltage ΔVm and a feed-through voltage ΔVn each result from a capacitance Cgd (a parasitic capacitance between the scanning signal line and the pixel electrode). A suitable value of a voltage Vcom of the common electrode is dependent on the feed-through voltage ΔVm and the feed-through voltage ΔVn. The feed-through voltage ΔVm is dependent on the returning edge of the scanning pulse Pm, and the feed-through voltage ΔVn is dependent on the returning edge of the scanning pulse Pn. Therefore, by causing the returning edge of the scanning pulse Pm and the returning edge of the scanning pulse Pn to match each other, the suitable value of the voltage Vcom for the side area SA1, the suitable value of the voltage Vcom for the side area SA2, and the suitable value of the voltage Vcom for the main area MA are caused to match each other. This suppresses luminance unevenness.

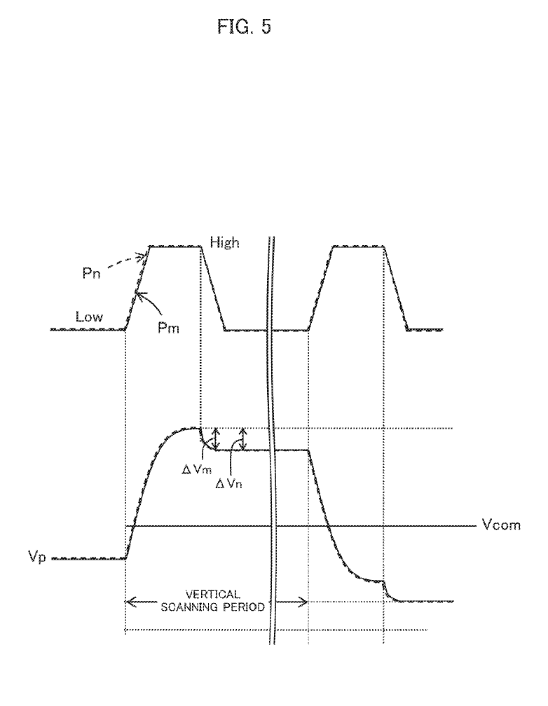

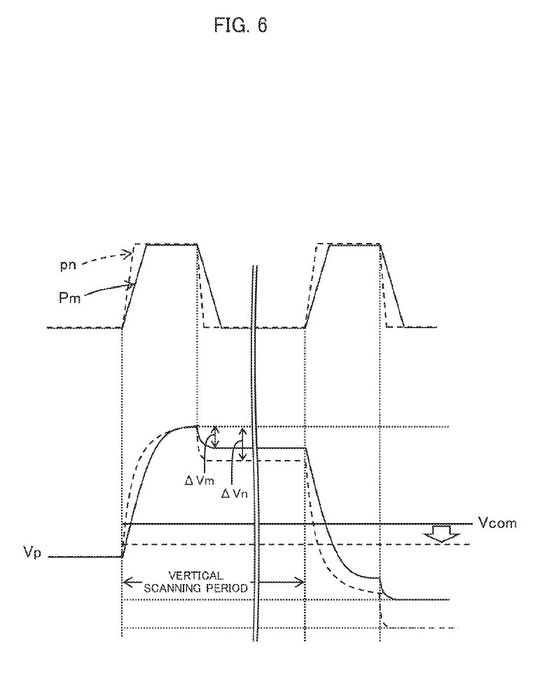

Note that, in a case where the output circuits Xn and XN are caused to be identical, in configuration, to the output circuits Xm and XM, respectively, a scanning pulse pn outputted from the output circuit Xn returns (drops) more steeply than the scanning pulse Pm outputted from the output circuit Xm, so that ΔVn becomes greater than ΔVm. This causes the suitable value of the voltage Vcom for the side area SA1 and the suitable value of the voltage Vcom for the side area SA2 to shift in the negative direction from the suitable value of the voltage Vcom for the main area MA (see FIG. 6), and may cause luminance unevenness or image sticking (decrease in reliability). Note that a shift of the suitable value of the voltage Vcom can be adjusted by adjusting a data signal to be written in each pixel electrode PE. However, in this case, it is disadvantageously necessary to customize the source driver SD. According to Embodiment 1, by designing a GDM (gate driver monolithic circuit) to the active matrix substrate 3, there is an advantage that it is possible to deal with luminance unevenness.

Note that the flip flop Fm illustrated in (a) of FIG. 2 is, for example, an RS flip flop having a set terminal S, a reset terminal R, and an output terminal Qm. The output terminal Qm is connected to the output circuit Xm. The output circuit Xm is connected to a set terminal S of a subsequent flip flop Fm+1 and to a reset terminal R of a preceding flip flop.

According to (a) of FIG. 4, the output circuit Xm is constituted by the transistor Tm (output transistor) of an re-channel type. A gate terminal of the transistor Tm is connected to the output terminal Qm of the flip flop Fm, one of conductive terminals of the transistor Tm is connected to a supply line through which a clock signal CKa is supplied, and the other one of the conductive terminals of the transistor Tm is connected to the scanning signal line Gm. Similarly, the output circuit XM is constituted by the transistor TM (output transistor) of an n-channel type. A gate terminal of the transistor TM is connected to an output terminal QM of the flip flop FM, one of conductive terminals of the transistor TM is connected to a supply line through which a clock signal CKa is supplied, and the other one of the conductive terminals of the transistor TM is connected to the scanning signal line Gm. Similarly, the output circuit Xn is constituted by the transistor Tn (output transistor) of an n-channel type. A gate terminal of the transistor Tn is connected to an output terminal Qn of the flip flop Fn, one of conductive terminals of the transistor Tn is connected to a supply line through which a clock signal CKb (which is in opposite phase from the clock signal CKa) is supplied, and the other one of the conductive terminals of the transistor Tn is connected to the scanning signal line Gn. Similarly, the output circuit XN is constituted by the transistor TN (output transistor) of an n-channel type. A gate terminal of the transistor TN is connected to an output terminal QN of the flip flop FN, one of conductive terminals of the transistor TN is connected to a supply line through which a clock signal CKb is supplied, and the other one of the conductive terminals of the transistor TN is connected to the scanning signal line GN.

According to (a) of FIG. 4, in a case where a clock signal changes from “Low” to “High” while an output of a flip flop is “High,” a scanning pulse rises. In a case where the clock signal changes from “High” to “Low,” the scanning pulse changes from “High” to “Low.”

According to (a) of FIG. 4, the driving capability of the transistor Tn is lower than that of the transistor Tm, and the driving capability of the transistor TN is lower than that of the transistor TM (specific examples will be described later).

Note that the configurations illustrated in (a) of FIG. 4 can be altered as illustrated in (b) of FIG. 4. Specifically, a diode-connected transistor Tk is inserted between a gate terminal (hereinafter, referred to as a node Nd) of an output transistor (Tm, TM, Tn, TN) and an output terminal (Qm, QM, Qn, QN) of a flip flop, and a bootstrap capacitance Cb is formed between the node Nd and a scanning signal line (Gm, GM, Gn, GN).

In a case of (b) of FIG. 4, in a case where an output from the output terminal (Qm, QM, Qn, QN) of the flip flop changes to “High,” the node nd is pre-charged, via the transistor Tk, to an electric potential which has dropped from an output voltage of the flip flop by a threshold electric potential of the transistor Tk. Thereafter, in a case where a clock signal rises, the electric potential of the node nd is raised via the bootstrap capacitance Cb. In so doing, the transistor Tk is in an off-state, and the node nd is in a floating state. Therefore, the electric potential of the node nd is raised to the output voltage of the flip flop or more, and the clock signal is outputted to the scanning signal line (Gm, GM, Gn, GN) without a drop of a “High” level of the clock signal by a threshold electric potential of the transistor (Tm, TM, Tn, TN). This makes it possible to prevent a decrease in “High” level of a scanning pulse. Note that the bootstrap capacitance Cb can be a capacitance element or can be alternatively a parasitic capacitance of the output transistor (Tm, TM, Tn, TN).

According to (c) of FIG. 4, the output circuit Xm is constituted by (i) a NAND to which the clock signal CKa and an output from the output terminal Qm of the flip flop Fm are inputted, (ii) a transistor Tp which is of a p-channel type and which has conductive terminals one of which is connected to a Vdd (high-potential power source), and (iii) the transistor Tm of the n-channel type. The gate terminal of the transistor Tm is connected to an output terminal of the NAND and to a gate terminal of the transistor Tp, one of the conductive terminals of the transistor Tm is connected to a Vss (low-potential power source), and the other one of the conductive terminals of the transistor Tm is connected to the scanning signal line Gm and to the other one of the conductive terminals of the transistor Tp. Similarly, the output circuit XM is constituted by (i) a NAND to which the clock signal CKa and an output from the output terminal QM of the flip flop FM are inputted, (ii) a transistor Tp which is of a p-channel type and which has conductive terminals one of which is connected to the Vdd (high-potential power source), and (iii) the transistor TM of the n-channel type. The gate terminal of the transistor TM is connected to an output terminal of the NAND and to a gate terminal of the transistor Tp, one of the conductive terminals of the transistor TM is connected to the Vss, and the other one of the conductive terminals of the transistor TM is connected to the scanning signal line Gm and to the other one of the conductive terminals of the transistor Tp. Similarly, the output circuit Xn is constituted by (i) a NAND to which the clock signal CKb and an output from the output terminal Qn of the flip flop Fn are inputted, (ii) a transistor Tp which is of a p-channel type and which has conductive terminals one of which is connected to the Vdd, and (iii) the transistor Tn of the n-channel type. The gate terminal of the transistor Tn is connected to an output terminal of the NAND and to a gate terminal of the transistor Tp, one of the conductive terminals of the transistor Tn is connected to the Vss, and the other one of the conductive terminals of the transistor Tn is connected to the scanning signal line Gn and to the other one of the conductive terminals of the transistor Tp. Similarly, the output circuit XN is constituted by (i) a NAND to which the clock signal CKb and an output from the output terminal QN of the flip flop FN are inputted, (ii) a transistor Tp which is of a p-channel type and which has conductive terminals one of which is connected to the Vdd, and (iii) the transistor TN of the n-channel type. The gate terminal of the transistor TN is connected to an output terminal of the NAND and to a gate terminal of the transistor Tp, one of the conductive terminals of the transistor TN is connected to the Vss, and the other one of the conductive terminals of the transistor TN is connected to the scanning signal line GN and to the other one of the conductive terminals of the transistor Tp.

According to (c) of FIG. 4, the driving capability of the transistor Tn is lower than that of the transistor Tm, and the driving capability of the transistor TN is lower than that of the transistor TM (specific examples will be described later).

Each NAND illustrated in (c) of FIG. 4 can be replaced with a circuit which employs an inverter iv, an analog switch as, and a transistor Tq of an n-channel type, as illustrated in (d) of FIG. 4. An output and an inverted output of a flip flop are inputted into respective two control terminals of the analog switch as. A clock signal is inputted into one of conductive terminals of the analog switch as. The other one of the conductive terminal of the analog switch as is connected to an input terminal of the inverter iv. The inverted output of the flip flop is inputted into a gate terminal of the transistor Tq. One of conductive terminals of the transistor Tq is connected to the Vss, and the other one of the conductive terminals of the transistor Tq is connected to the input terminal of the inverter iv.

According to (e) of FIG. 4, the output circuit Xm is constituted by a CMOS analog switch which is obtained by connecting conductive terminals of a transistor Tma (output transistor) of a p-channel type to respective conductive terminals of a transistor Tmb (output transistor) of an re-channel type. A gate terminal of the transistor Tma is connected to the output terminal Qm of the flip flop Fm, one of the conductive terminals of the transistor Tma is connected to the supply line through which the clock signal CKa is supplied, and the other one of the conductive terminals of the transistor Tma is connected to the scanning signal line Gm. A gate terminal of the transistor Tmb is connected to an inverted output terminal Qbm of the flip flop Fm, one of the conductive terminals of the transistor Tmb is connected to the supply line through which the clock signal CKa is supplied, and the other one of the conductive terminals of the transistor Tmb is connected to the scanning signal line Gm. Similarly, the output circuit XM is constituted by a CMOS analog switch which is obtained by connecting conductive terminals of a transistor TMa (output transistor) of a p-channel type to respective conductive terminals of a transistor TMb (output transistor) of an n-channel type. A gate terminal of the transistor TMa is connected to the output terminal QM of the flip flop FM, one of the conductive terminals of the transistor TMa is connected to the supply line through which the clock signal CKa is supplied, and the other one of the conductive terminals of the transistor TMa is connected to the scanning signal line Gm. A gate terminal of the transistor TMb is connected to an inverted output terminal QbM of the flip flop FM, one of the conductive terminals of the transistor TMb is connected to the supply line through which the clock signal CKa is supplied, and the other one of the conductive terminals of the transistor TMb is connected to the scanning signal line Gm. Similarly, the output circuit Xn is constituted by a CMOS analog switch which is obtained by connecting conductive terminals of a transistor Tna (output transistor) of a p-channel type to respective conductive terminals of a transistor Tnb (output transistor) of an n-channel type. A gate terminal of the transistor Tna is connected to the output terminal Qn of the flip flop Fn, one of the conductive terminals of the transistor Tna is connected to the supply line through which the clock signal CKb is supplied, and the other one of the conductive terminals of the transistor Tna is connected to the scanning signal line Gn. A gate terminal of the transistor Tnb is connected to an inverted output terminal Qbn of the flip flop Fn, one of the conductive terminals of the transistor Tnb is connected to the supply line through which the clock signal CKb is supplied, and the other one of the conductive terminals of the transistor Tnb is connected to the scanning signal line Gn. Similarly, the output circuit XN is constituted by a CMOS analog switch which is obtained by connecting conductive terminals of a transistor TNa (output transistor) of a p-channel type to respective conductive terminals of a transistor TNb (output transistor) of an n-channel type. A gate terminal of the transistor TNa is connected to the output terminal QN of the flip flop FN, one of the conductive terminals of the transistor TNa is connected to the supply line through which the clock signal CKb is supplied, and the other one of the conductive terminals of the transistor TNa is connected to the scanning signal line GN. A gate terminal of the transistor TNb is connected to an inverted output terminal QbN of the flip flop FN, one of the conductive terminals of the transistor TNb is connected to the supply line through which the clock signal CKb is supplied, and the other one of the conductive terminals of the transistor TNb is connected to the scanning signal line GN.

According to (e) of FIG. 4, in a case where a clock signal changes from “Low” to “High” while an output of a flip flop is “High” and an inverted output of the flip flop is “Low,” a scanning pulse rises. In a case where the clock signal changes from “High” to “Low,” the scanning pulse returns.

According to (e) of FIG. 4, a driving capability of the transistor Tna is lower than that of the transistor Tma, a driving capability of the transistor Tnb is lower than that of the transistor Tmb, a driving capability of the transistor TNa is lower than that of the transistor TMa, and a driving capability of the transistor TNb is lower than that of the transistor TMb (specific examples will be described later).

Note that the output circuits Xm, XM, Xn, and XN can be configured such that the driving capability of the transistor Tna is lower than that of the transistor Tma, the driving capability of the transistor Tnb is equivalent to that of the transistor Tmb, the driving capability of the transistor TNa is lower than that of the transistor TMa, and the driving capability of the transistor TNb is equivalent to that of the transistor TMb. Alternatively, the output circuits Xm, XM, Xn, and XN can be configured such that the driving capability of the transistor Tna is equivalent to that of the transistor Tma, the driving capability of the transistor Tnb is lower than that of the transistor Tmb, the driving capability of the transistor TNa is equivalent to that of the transistor TMa, and the driving capability of the transistor TNb is lower than that of the transistor TMb. The driving capability of each of the transistors Tna, Tnb, TNa, and TNb can be determined so that a rising edge and the returning edge of the scanning pulse Pn become suitable.

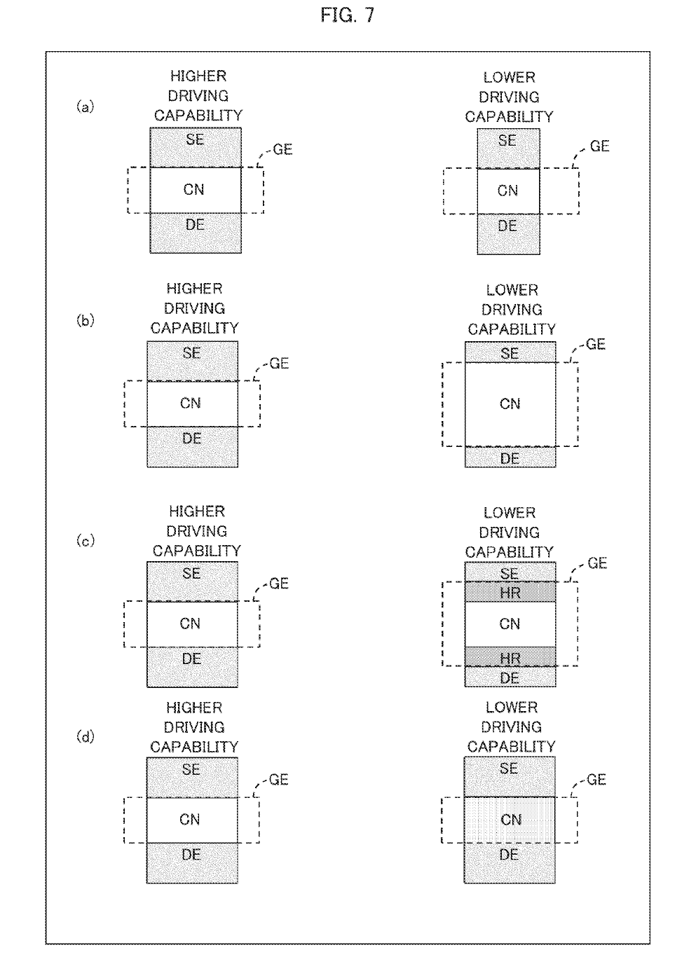

FIG. 7 is a plan view illustrating configurations of output transistors. A configuration (higher in driving capability) illustrated on a left side of each of (a) through (d) of FIG. 7 corresponds to the transistors (output transistors) Tm, TM, Tma, Tmb, TMa, and TMb illustrated in FIG. 4, and a configuration (lower in driving capability) illustrated on a right side of each of (a) through (d) of FIG. 7 corresponds to the transistors (output transistors) Tn, TN, Tna, Tnb, TNa, and TNb illustrated in FIG. 4. Each output transistor is formed in a process of producing the active matrix substrate 3. An oxide semiconductor (for example, an In—Ga—Zn—O semiconductor), low-temperature polysilicon (LTPS), amorphous silicon, or the like can be used for a channel of each output transistor.

According to (a) of FIG. 7, a driving capability is lowered by, in a case where a source electrode (source region) SE, a drain electrode (drain region) DE, and a channel CN are formed, causing (i) a width of the channel CN to be narrower and (ii) a length of the channel CN to be remain unchanged (a size of a transistor also becomes smaller). According to (b) of FIG. 7, the driving capability is lowered by causing (i) the width of the channel CN to remain unchanged and (ii) the length of the channel CN to be longer. According to (c) of FIG. 7, the driving capability is lowered by (i) causing the length and the width of the channel CN to remain unchanged and (ii) forming high-resistance regions HR on both sides of the channel CN. According to (d) of FIG. 7, the driving capability is lowered by (i) causing the length and the width of the channel CN to remain unchanged and (ii) changing an amount of ionic impurities with which the channel CN is doped.

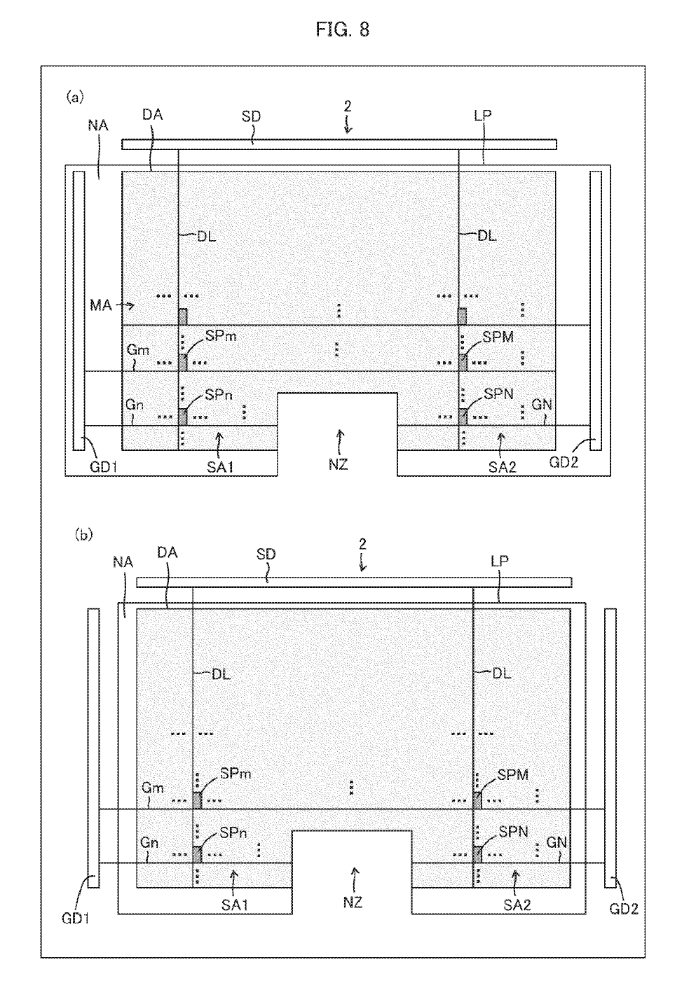

FIG. 8 is a schematic view illustrating variations of the display device in accordance with Embodiment 1. According to (a) of FIG. 1, the scanning signal line Gm, which is provided so as to pass through the main area MA, is connected to both of the gate driver GD1 and the gate driver GD2. However, the display device is not limited to such a configuration. A display device can be configured such that each scanning signal line is connected to a single gate driver (GD1 or GD2) as illustrated in (a) of FIG. 8. Also in this case, since a scanning signal line Gn, which is provided so as to pass through a side area, and a scanning signal line GN, which is provided so as to pass through another side area, are each a low-load scanning signal line, output circuits Xm, XM, Xn, and XN are configured as illustrated in FIG. 4.

According to (a) of FIG. 1, the gate driver GD1 and the gate driver GD2 are monolithically provided to the active matrix substrate 3. However, the display device is not limited to such a configuration. As illustrated in (b) of FIG. 8, a display device can be configured such that a gate driver GD1 and a gate driver GD2 are provided on respective IC substrates each of which is different from a liquid crystal panel LP.

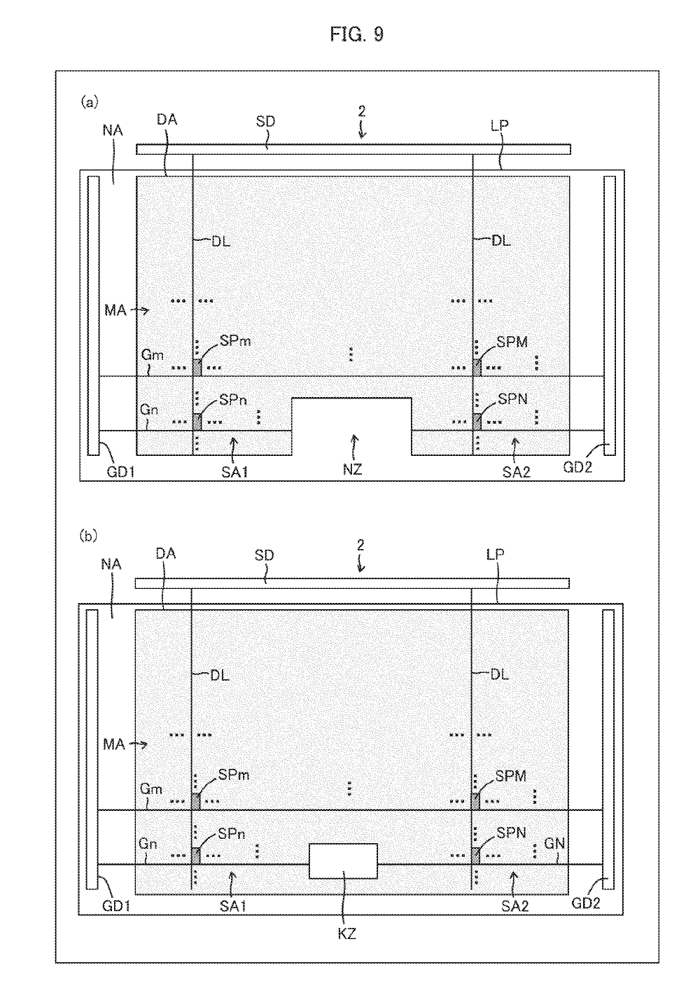

FIG. 9 is a schematic view illustrating other variations of the display device in accordance with Embodiment 1. As illustrated in (a) of FIG. 9, a display device can be configured such that a liquid crystal panel LP itself is rectangular-shaped and a cutout NZ (area in which no sub pixel is provided) is provided in a display area DA. Alternatively, as illustrated in (b) of FIG. 9, a display device can be configured such that a hole KZ (area in which no sub pixel is provided) is provided in a display area DA. Also in these cases, since a scanning signal line Gn is a low-load scanning signal line as compared with a scanning signal line Gm (the number of sub pixels connected to the scanning signal line Gn is lower than the number of sub pixels connected to the scanning signal line Gm), output circuits Xm, XM, Xn, and XN are configured as illustrated in FIG. 4.

### Embodiment 2

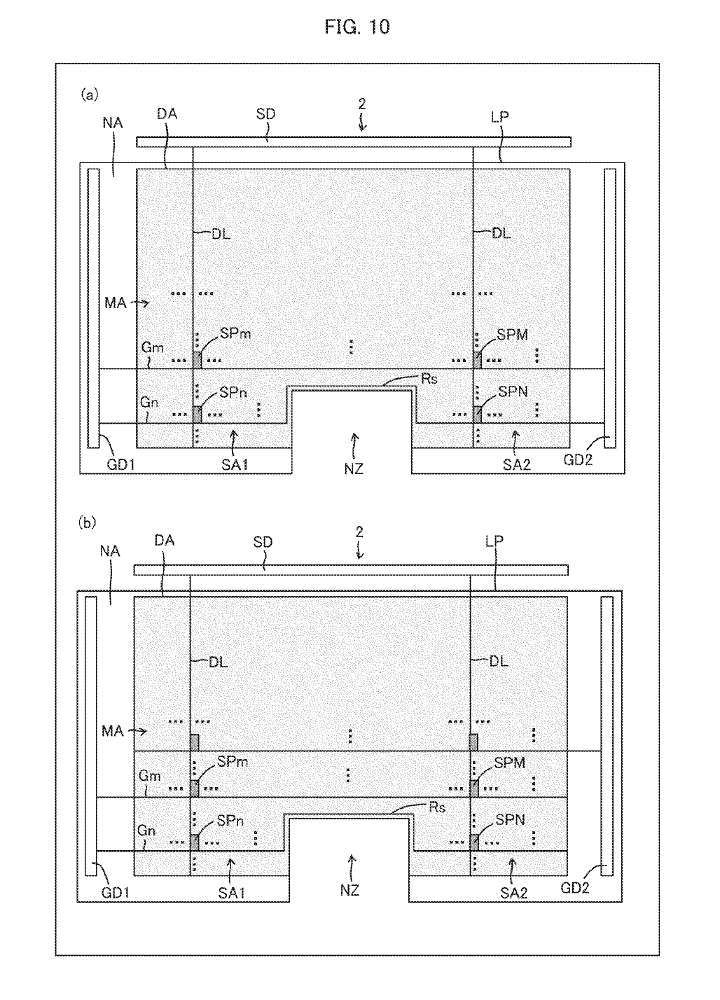

FIG. 10 is a schematic view illustrating configurations of a display device in accordance with Embodiment 2. According to Embodiment 2, as illustrated in (a) of FIG. 10, a scanning signal line Gn is provided so as to pass through a side area SA1 and a side area SA2, and is connected to both of a gate driver GD1 and a gate driver GD2. Specifically, the scanning signal line Gn has a detouring part Rs for avoiding a cutout NZ. Also in this case, since the scanning signal line Gn is a low-load scanning signal line as compared with a scanning signal line Gm (the number of sub pixels connected to the scanning signal line Gn is lower than the number of sub pixels connected to the scanning signal line Gm), output circuits Xm, XM, Xn, and XN are configured as illustrated in FIG. 4. Note that each scanning signal line can be connected to a single gate driver (GD1 or GD2) as illustrated in (b) of FIG. 10.

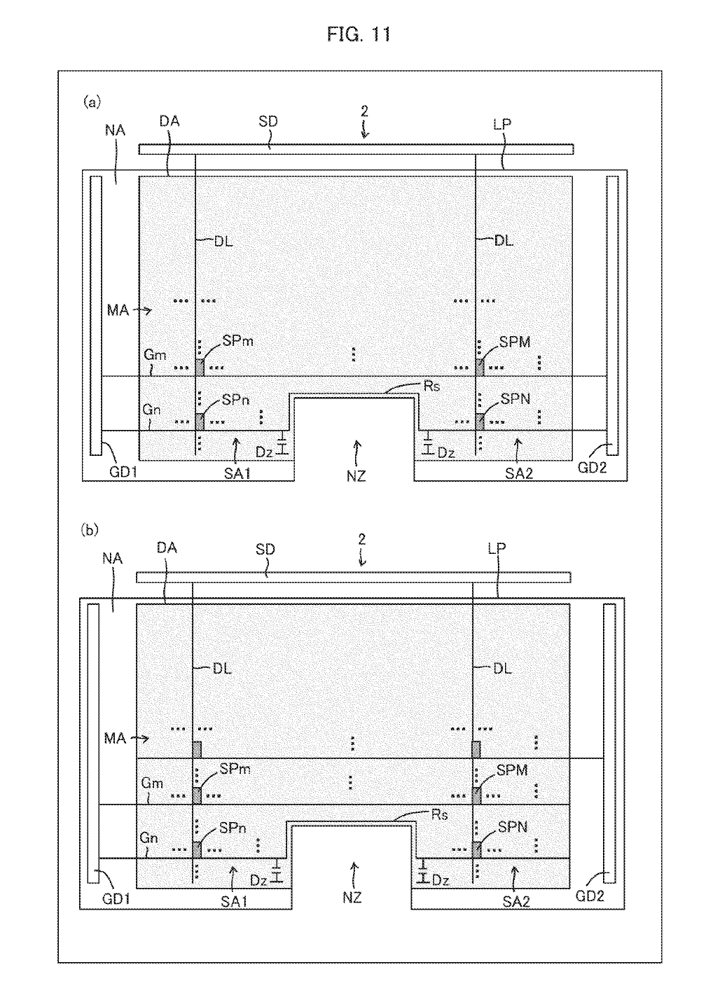

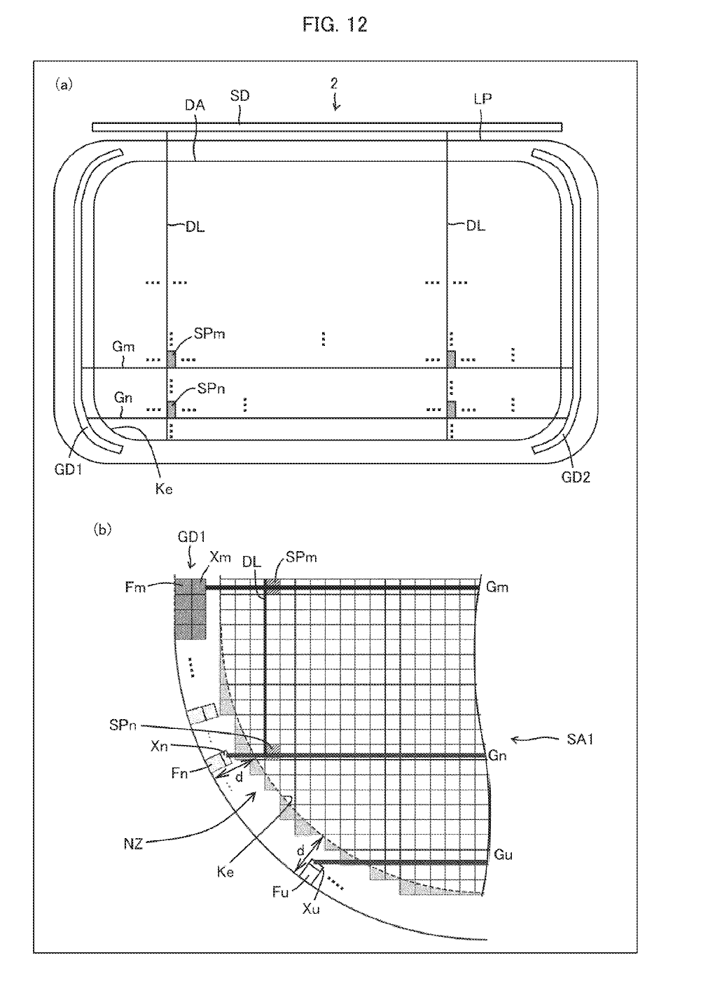

FIG. 11 is a schematic view illustrating variations of the display device in accordance with Embodiment 2. According to FIG. 11, a scanning signal line Gn is provided so as to pass through a side area SA1 and a side area SA2, and is connected to both of a gate driver GD1 and a gate driver GD2. Besides, electric conductors Dz, each of which causes a capacitance to be formed between itself and the scanning signal line Gn, are provided in a vicinity of a cutout NZ. This makes it possible to adjust (increase) a load on the scanning signal line Gn. Note that a constant electric potential, such as a voltage Vcom of a common electrode, is supplied to each of the electric conductors Dz. Note that each scanning signal line can be connected to a single gate driver (GD1 or GD2) as illustrated in (b) of FIG. 11.

### Embodiment 3

(a) of FIG. 12 is a schematic view illustrating a configuration of a display device in accordance with Embodiment 3. (b) of FIG. 12 is an enlarged view of a corner of a display area. According to FIG. 12, corners of a display area DA are rounded so that the display area DA has arc-shaped edges (round edges). A load on a scanning signal line Gn, which is provided so as to pass through one (side area SA1 located by a cutout NZ) of the corners is lighter than that on a scanning signal line Gm which is provided so as to pass through an area located further in the middle than the corners as viewed in an up-and-down direction of (a) of FIG. 12. That is, the number of sub pixels (including a sub pixel SPn) connected to the scanning signal line Gn is lower than the number of sub pixels (including a sub pixel SPm) connected to the scanning signal line Gm. Therefore, output circuits Xm and Xn are configured as illustrated in FIG. 4.

In a case where a corner edge Ke of the display area DA is arc-shaped, an end part of a gate driver GD1 which is GDM-structured is formed so as to extend along the corner edge Ke (so as to be located at an equal distance from the corner edge Ke). In so doing, by configuring the output circuit Xn, which is included in the end part of the gate driver GD1, as illustrated in FIG. 4 and (a) of FIG. 7 (for example, by causing a width of a channel of a transistor Tn to be narrower), it is possible to make a size of the output circuit Xn smaller than that of the output circuit Xm. This makes it possible to (i) reduce a region in which the end part (round part) of the gate driver GD1 is formed and (ii) accordingly reduce a non-display area (frame region) which surrounds the display area DA, while suppressing horizontally striped luminance unevenness (luminance unevenness between an upper end part, a lower end part, and a middle part). Similar configurations apply to the other three of the corners than the one illustrated in (b) of FIG. 12.

Note that, with regard to the scanning signal line Gn and a scanning signal line Gu each of which is provided so as to pass through the one of the corners, the scanning signal line Gu, which is provided so as to pass through an area located on an outer side of the scanning signal line Gn as viewed in the up-and-down direction of (a) of FIG. 12, is a low-load scanning signal line as compared with the scanning signal line Gn (the number of sub pixels connected to the scanning signal line Gu is lower than the number of sub pixels connected to the scanning signal line Gn). Therefore, it is possible to cause a driving capability of an output transistor of an output circuit Xu connected to the scanning signal line Gu to be lower than that of an output transistor of the output circuit Xn. Note that a flip flop Fn connected to the output circuit Xn and a flip flop Fu connected to the output circuit Xu are located at an equal distance d from the corner edge Ke.

[Recap]

A display device in accordance with an embodiment of the present invention is suitable for not only a liquid crystal display but also an OLED (Organic Light Emitting Diode) display, a QLED (Quantum dot Light Emitting Diode) display, and the like.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### Aspect 1

A display device including: an mth scanning signal line to which a plurality of sub pixels are connected; an nth scanning signal line to which a sub pixel is connected, the number of sub pixels which are connected to the nth scanning signal line being lower than the number of sub pixels which are connected to the mth scanning signal line; and a driver which includes a plurality of output circuits and which drives the mth scanning signal line and the nth scanning signal line, an mth one of the plurality of output circuits including an mth output transistor connected to the mth scanning signal line, an nth one of the plurality of output circuits including an nth output transistor connected to the nth scanning signal line, a driving capability of the nth output transistor being lower than that of the mth output transistor.

### Aspect 2

The display device as set forth in, for example, Aspect 1, further including a display area in which a cutout or a hole is provided so that the display area has an irregular shape.

### Aspect 3

The display device as set forth in, for example, Aspect 2, wherein: the display area includes a side area which is located by one of sides of the cutout or the hole; and the nth scanning signal line is provided so as to pass through the side area.

### Aspect 4

The display device as set forth in, for example, any one of Aspects 1 through 3, further including an electric conductor which causes a capacitance to be formed between the electric conductor and the nth scanning signal line and to which a constant voltage is supplied.

### Aspect 5

The display device as set forth in, for example, any one of Aspects 1 through 4, wherein a size of the nth output transistor is smaller than that of the mth output transistor.

### Aspect 6

The display device as set forth in, for example, Aspect 2, wherein: a corner edge of the display area is rounded or oblique with respect to a direction in which the nth scanning signal line extends; an end part of the driver is provided on an outer side of the corner edge so as to be located at an equal distance from the corner edge; and the nth one of the plurality of output circuits is included in the end part of the driver.

### Aspect 7

A driver including a plurality of output circuits, the driver driving (i) an mth scanning signal line to which a plurality of sub pixels are connected and (ii) an nth scanning signal line to which a sub pixel is connected, the number of sub pixels which are connected to the nth scanning signal line being lower than the number of sub pixels which are connected to the mth scanning signal line, an mth one of the plurality of output circuits including an mth output transistor connected to the mth scanning signal line, an nth one of the plurality of output circuits including an nth output transistor connected to the nth scanning signal line, a driving capability of the nth output transistor being lower than that of the mth output transistor.

### REFERENCE SIGNS LIST

2 Display device
SPm, SPn Sub pixel
Gm, Gn Scanning signal line
Xm, Xn Output circuit
Tm, Tn (Output) transistor
SA1, SA2 Side area
NZ Cutout

1. A display device comprising:
an mth scanning signal line to which a plurality of sub pixels are connected;
an nth scanning signal line to which at least one sub pixel is connected, the number of sub pixels which are connected to the nth scanning signal line being lower than the number of sub pixels which are connected to the mth scanning signal line; and
a driver which includes a plurality of output circuits and which drives the mth scanning signal line and the nth scanning signal line,
m being a natural number,
n being a natural number other than m,
an mth one of the plurality of output circuits including an mth output transistor connected to the mth scanning signal line,
an nth one of the plurality of output circuits including an nth output transistor connected to the nth scanning signal line,
a driving capability of the nth output transistor being lower than that of the mth output transistor.

2. The display device as set forth in claim 1, wherein the display device has a display area in which a cutout or a hole is provided so that the display area has an irregular shape.

3. The display device as set forth in claim 2, wherein:
the display area includes a side area which is located by one of sides of the cutout or the hole; and
the nth scanning signal line is provided so as to pass through the side area.

4. The display device as set forth in claim 1, further comprising an electric conductor which causes a capacitance to be formed between the electric conductor and the nth scanning signal line and to which a constant voltage is supplied.

5. The display device as set forth in claim 1, wherein a size of the nth output transistor is smaller than that of the mth output transistor.

6. The display device as set forth in claim 2, wherein:
a corner edge of the display area is rounded or oblique with respect to a direction in which the nth scanning signal line extends;
an end part of the driver is provided on an outer side of the corner edge so as to be located at an equal distance from the corner edge; and
the nth one of the plurality of output circuits is included in the end part of the driver.

7. A driver comprising a plurality of output circuits, the driver driving (i) an mth scanning signal line to which a plurality of sub pixels are connected and (ii) an nth scanning signal line to which at least one sub pixel is connected, the number of sub pixels which are connected to the nth scanning signal line being lower than the number of sub pixels which are connected to the mth scanning signal line,
m being a natural number,
n being a natural number other than m,
an mth one of the plurality of output circuits including an mth output transistor connected to the mth scanning signal line,
an nth one of the plurality of output circuits including an nth output transistor connected to the nth scanning signal line,
a driving capability of the nth output transistor being lower than that of the mth output transistor.
